(19) United States
(12) Patent Application Publication
(10) Pub. No.: US 2010/0305350 A1
(43) Pub. Date: Dec. 2, 2010

(54) DIAMIDINE METAL COMPLEX AND METHOD OF USE

(76) Inventor: Subbareddy Kanagasabapathy, Lexington, KY (US)

Correspondence Address: WOOD, HERRON & EVANS, LLP, 2700 CAREW TOWER, 441 VINE STREET, CINCINNATI, OH, 45202, US

(21) Appl. No.: 12/752,359

(22) Filed: Apr. 1, 2010

Related U.S. Application Data
(60) Provisional application No. 61/183,193, filed on Jun. 2, 2009.

(51) Int. Cl. C07F 1/08

(52) U.S. Cl. 556/32

(57) ABSTRACT

A diamidine compound is used to complex to a catalytic metal atom. This can be dissolved in an organic solution for homogenous catalytic reactions, such as a hydrogenation, polymerization reaction. The metal complex can be separated from the reactant solution after the reaction by bubbling carbon dioxide through the solution causing the formation of diamidinium bicarbonate, which is insoluble in organic solution and can be recovered in an aqueous medium. The diamidinium bicarbonate can be further converted back into an organic soluble diamidine by bubbling the aqueous solution with argon or nitrogen, permitting the reuse of the catalyst in homogeneous catalytic reactions.

### BACKGROUND OF THE INVENTION

The term catalysis includes heterogeneous, homogeneous, and biological (enzyme) catalysis. To a large extent, the heterogeneous catalysis was first applied commercially soon after it was discovered. In spite of its draw backs such as the lack of deeper mechanistic understanding of the multiphase processes and its lower reaction rates, the ratio of heterogeneous to homogeneous catalysis is about 75:25. This is mainly because of the ability to recover catalyst from the product in a homogeneous catalysis.

Homogeneous catalysis, on the other hand, has many attractive properties such as high activities, high turnover, frequency, and high selectivity. Homogeneous catalysis is one of the most important areas of contemporary chemistry and chemical technology. Homogeneously catalyzed processes include hydroformylation, carbonylation, oxidation, hydrogenation, metathesis, polymerization and hydrocyanation.

The basic problem of homogeneously catalyzed processes is the separation of the product from the catalyst, which is homogenized in solvent along with products and unreacted raw materials. The process stages necessary to recover the catalyst usually include thermal operations such as distillation, decomposition, transformation, and rectification, which normally lead to thermal stresses on the catalyst. These can cause decomposition reactions and progressive deactivation during the lifetime of the catalyst. Furthermore, thermal separation processes seldom give quantitative recovery of the catalyst, which causes loss of productivity through loss of metal. These problems increase the manufacturing cost. Over the last several decades, extensive studies have been carried out on the separation of catalysts from industrial homogenous catalysis reactions.

One of the approaches for the catalyst separation is the use of Water-soluble metal complex catalysts, which have been intensively investigated. This approach combines the advantages of homogeneous and heterogeneous catalysis: simple and complete separation of the product from the catalyst, high activity, and high selectivity. Another approach, which has been practiced for several decades without any spectacular success, is to immobilize solid complex catalysts on solid supports. The continuous loss of the metal due to metal leaching to the product system and low reaction rates are significant disadvantages. However, the immobilization of a catalyst in a “mobile phase”, that is, an aqueous solution immiscible with the product phase, represents an almost ideal combination of homogeneous and heterogeneous reaction processes. Most of the other catalyst recovery methods have some drawbacks that still present difficulties.

### SUMMARY OF THE INVENTION

The present invention is premised on the realization that a diamidine compound can be complexed to a metal and act as a catalyst. The diamidine complex exhibits reversible solubility in inorganic and organic solvents. In the presence of carbon dioxide, the amidine moiety forms amidinium bicarbonate, which is water soluble, whereas the amidine moiety itself is soluble in organic solvents. Thus, a diamidine compound complexed to a metal atom can be used as a catalyst and recovered from the system by passing carbon dioxide through the system to cause the amidine metal complex to form the amidinium carbonate, which is insoluble in organic solvents, and precipitates out of solution for recovery.

The objects and advantages of the present invention will be further appreciated in light of the following detailed description.

### DETAILED DESCRIPTION

A diamidine compound is complexed to a metal ion and its solubility is controlled by adding carbon dioxide or an inert gas into a solution containing the compound.

The compound has the structure shown in Formula 1,

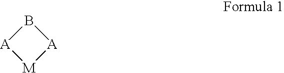

In this complex, A represents the amidine moeities, B represents a tether group binding the amidine moieties together, and M represents a metal complexed to the two amidine moieties.

As shown hereinafter, the tether group can be any difunctional organic molecule which is not so large that it prevents the amidinium bicarbonate from being water soluble. In particular, the tethering molecule can be, for example, a difunctional C₂-C₁₂. It can also be a difunctional cycloalkyl, aryl, as well as a difunctional polyaromatic moiety.

In its simplest form, the diamidine will have the structure shown in Formula 2 (shown without the metal atom).

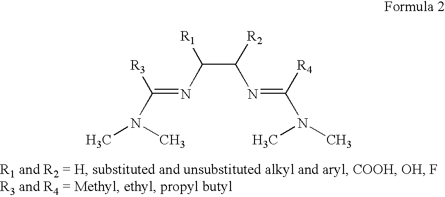

The compound of the present invention is formed by reacting a diamine compound incorporating the tether group with an amine diacetal. An exemplary reaction is shown in the attached Formula 3, below,

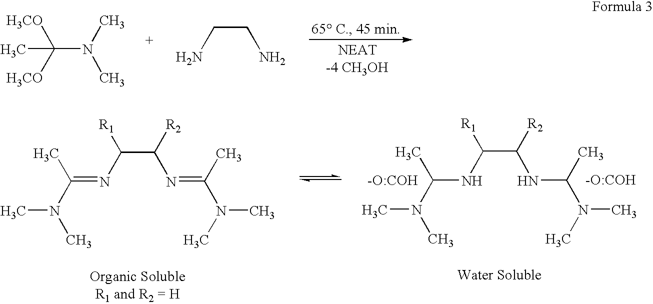

In this reaction, ethylene diamine reacts with 1di-ethylamino 1,1 diacetal ethane (dimethylamine dimethylacetal) at elevated temperature, generally about 75° C. with mixing for a period of time effective to cause the reaction to occur. This reaction is conducted without any solvent.

Generally, the reaction time will be from about 15 min to about 2 hrs, with one hour being adequate. This reaction will form the product shown in formula 2, and produce methanol as a byproduct.

The diamidine of the present invention can also be formed by reacting an aminal ester with a diamine. The reaction is set forth in J Praktchem. 2000-342 No. 7, page 682. Again, this reaction occurs naturally at elevated temperature in an organic solution.

As indicated, the tether group can be a large variety of different organic moieties with the proviso that the tether group not be so large that the formed diamidine is insoluble in an organic solution in the presence of carbon dioxide, in other words in the amidinium carbonate form. Further, the tether group cannot be so hydrophilic as to make the amidine complex soluble in water. Suitable compositions for use in the present invention are shown in the following formulas, Formulae 4-12,

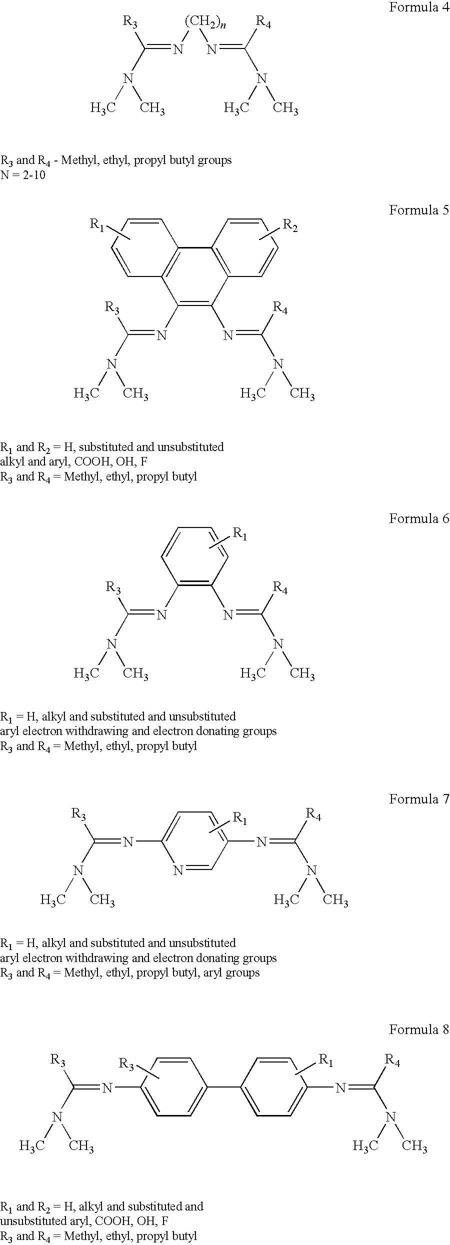

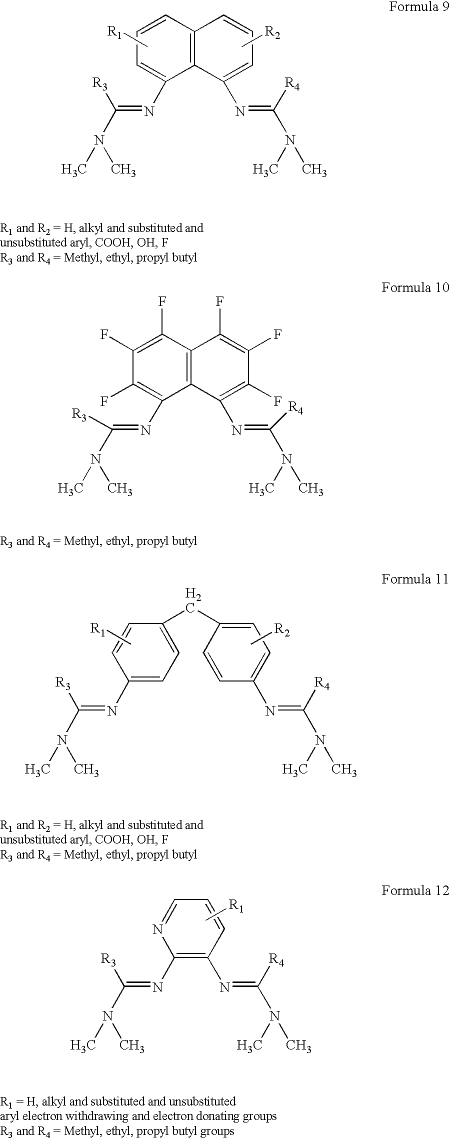

To form the metal complex, the metal containing molecule is dissolved generally in an appropriate organic solvent, and the diamidine complex of the present invention is simply blended with the metal containing solution. Generally, equal molar amounts of metal and diamidine compound can be used. However, a slight excess of diamidine may be desirable.

Alternately, the amidine compound can be added to a metal free organic solvent and carbon dioxide bubbled into the solution to cause the amidine compound to dissolve, forming the amidinium bicarbonate complex which is soluble in aqueous solution. A metal compound can then be dissolved in the aqueous solution, allowing it to complex with the diamidinium bicarbonate compound. This can be then converted back to the amidine compound by bubbling an inert gas, such as argon or nitrogen, into the aqueous solution. The amidine metal complex will then precipitate out of solution and can be separated and dried to permit it to be used in an organic solution.

The solubility of the amidine compound can also be reversed by subjecting the complex to carbon disulfide or to an acidic solution, such as hydrochloric acid or sulfuric acid.

The metal (in the form of a metal compound) can be any metal that acts as a catalyst. Typical metal catalysts include the lanthanides, actinides, as well as various metals in groups 3-9 of the periodic table, such as cobalt, nickel, iron and copper.

The metal complexes can be used in a homogenous reaction. If the reaction is conducted in an aqueous state, the metal amidine compound is simply used as the amidinium complex. Whereas, if the reaction is conducted in an organic solution, the amidine metal complex would be employed.

Subsequent to the reaction, the solubility of the catalyst complex is switched and precipitates out of solution. This can then be recovered and reused.

The organometallic complexes with switching ligands can be used as catalysts for reactions such as oxidation, reduction, carbonylation, oxidative carbonylation, hydroformylation, dimerization, trimerization, oligomerization, polymerization, isomerization, hydrogenation, hydrosilation, hydrocyanation, metathesis, carbon-hydrogen activation, hydration, acylation, Diels-Alger reactions, Heck reactions and other transformations.

The composition of the present invention can also be used to bind and sequester metals in other applications, such as pollution control, and the like. The composition of the present invention is particularly useful in removing trace amounts of harmful compounds, such as chromium, and the like, from aqueous solutions.

The present invention will be further appreciated in light of the detailed examples.

### Example 1

A sample of the ligand in Formula 2 (R₁ and R₂═H) was dissolved in tetrahydrofuran (THF). This clear solution was purged with CO₂. As soon as the CO₂ purging started, a white precipitate began forming. The precipitate was centrifuged and the solvent was separated from the white precipitate. Water was added to the precipitate. The precipitate immediately dissolved in water. That demonstrates that the THF soluble ligand became THF insoluble and water soluble.

### Example 2

A known amount of copper acetate was dissolved in THF. The color of the solution was blue. The ligand of Formula 2 was added into the blue clear solution. The color turned light green as soon as the ligand was added. When the green solution was purged with CO₂, the copper complex precipitated out immediately, leaving a crystal clear THF and a green chelated copper compound deposited at the bottom of the flask. The green chelated copper compound was separated from THF. Water was added to the flask completely dissolving the copper complex.

### Example 3

A known amount of copper acetate and a known amount of polystyrene foam were dissolved in THF. The color of the solution was blue. The ligand of Formula 2 was added to the blue clear solution. The color became light green as soon as the ligand was added. Then the light green solution was purged with CO₂. The copper complex became insoluble in THF and precipitated out immediately and deposited at the bottom of the flask. The green chelating copper compound was separate from THF Water was added to the flask and dissolved the copper complex. This demonstrates that the polystyrene can be separated from the catalyst.

These Examples demonstrate that the ligand of the present invention, will bind to a metal catalyst and can be easily separated from an organic solvent solution by simply bubbling carbon dioxide through the solution.

Further, as shown by Example 3, the ligand of the present invention can be used to separate the metal from a polymeric solution, polystyrene, thus demonstrating that the present invention can be used to recover catalysts from a homogenous polymerization reaction.

This has been a description of the present invention along with the preferred method of practicing the present invention. However, the invention itself should only be defined by the appended claims, WHEREIN WE CLAIM:

What is claimed is:

1. A compound comprising a first and a second amidine group tethered together wherein said amidine groups are bonded to a metal atom;
said compound being soluble in aqueous liquids when an effective amount of carbon dioxide is dissolved in said aqueous liquid;
said compound being insoluble in said aqueous liquid when said effective amount of carbon dioxide is not dissolved in said liquid.

2. A compound having the following general formula: 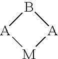
wherein M is a metal atom and wherein A represents an amidine moiety and wherein B is a tether group.

4. The method claimed in claim 2 wherein said B is a C₂-C₁₂ difunctional alkyl.

5. A method of catalyzing a reaction with a metal catalyst complex having the following formula 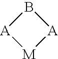
wherein A represents an amidine group, B represents a tether group bonding said amidine groups together, and M represents a catalytic metal atom;
dissolving said complex in a reactant-containing solution said metal thereby catalyzing said reaction;
reversing the solubility of said complex causing said compound to drop out of solution; and
recovering said compound.

6. The method claimed in claim 5 wherein said solubility is reversed by bubbling carbon dioxide through said solution.

8. The method claimed in claim 5 wherein said tether group is C₂-C₁₂ alkylene.
